(19) United States
(12) Patent Application Publication
(10) Pub. No.: US 2007/0181487 A1
(43) Pub. Date: Aug. 9, 2007

(54) FLUID FILTER WITH BYPASS VALVE FAILURE PROTECTION

(76) Inventor: Timothy H. Henderson, Gibsonville, NC (US)

Correspondence Address: ADAMS EVANS P.A., Suite 2350 Charlotte Plaza, 201 South College Street, CHARLOTTE, NC, 28244, US

(21) Appl. No.: 11/619,898

(22) Filed: Jan. 4, 2007

Related U.S. Application Data
(60) Provisional application No. 60/766,238, filed on Jan. 4, 2006.

(51) Int. Cl. B01D 21/24

(52) U.S. Cl. 210/424; 210/459; 137/544

(57) ABSTRACT

A valve failure protection device is provided for use in a fluid filter element of the type that includes a filter media that defines an inner passage having first and second ends and a bypass assembly positioned in the second flow path for selectively permitting flow through the first end and the inner passage to the second end. The valve failure protection device includes a perforated safety barrier adapted to be positioned in the inner passage downstream of the bypass assembly. The safety barrier is dimensioned to prevent the bypass assembly or pieces thereof from passing therethrough while permitting the flow of fluid along the inner passage to the second end.

### BACKGROUND OF THE INVENTION

This invention relates generally to fluid filters and more particularly to oil filters for aircraft engines and hydraulic systems.

Fluid filters are often incorporated into lubrication, hydraulic, or other liquid circuits and include filter media for removing impurities from the liquid. In particular, many hydraulic systems and engines used in commercial, general aviation, and military aircraft are equipped with filters. A conventional filter is configured such that a differential pressure, i.e. “delta P”, exists between the region outside, or upstream of, the filter media and the region inside, i.e., downstream of, the filter media when the filter is in use.

As the filter media becomes contaminated with impurities, or when an engine or system is started in extremely cold conditions, a relatively high differential pressure or “delta P” develops across the media. When a high differential pressure exists across the filter media, hydraulic forces within the filter element can crush the filter media or a central tube that typically supports the filter media. The distorted components can cause engine or system failure by allowing unfiltered oil to enter the system or by blocking the outlet of the filter.

In many cases, filters are protected from this type of failure by the incorporation of a bypass (pressure relief) valve in the filter assembly. For example, a conventional filter element includes two “end caps” secured at opposite ends of the filter media. One end cap is normally imperforate, and the other end cap normally has a hole or holes formed in it through which the oil flows to the engine or other system. One method of integrating the bypass valve into the filter assembly is to attach it to one of these end caps.

When a bypass valve is incorporated into a filter element assembly, it often includes a bypass hole that is formed in the end cap positioned opposite the outlet of the filter and a spring, a spring retainer, and a valve element for closing the bypass hole. Typically, the spring is retained by the spring retainer which is fastened to the end cap and located so that the valve element is normally pressed against the end cap such that the hole in the end cap is covered.

When a large delta P occurs, the valve element is pushed against the spring and is moved away from the end cap to which it is attached, thereby opening the bypass hole. In this manner, the differential pressure is relieved prior to its becoming so high that it causes filter element damage.

In many cases the spring retainer is attached to the cap by electric spot or projection welding. These welds are subject to continuous loading because of the retained spring pressure and are subject to intermittent higher loading due to the valve element moving against the spring when the bypass valve opens and occasionally fail. A weld failure sometimes allows bypass valve parts to become free within the central perforated tube and to migrate to the outlet end of the filter. There they can block off flow to the system.

In aircraft engines or fluid systems such an event can be particularly hazardous since the engine or system may fail or may have to be intentionally disabled due to lack of oil pressure. The loss of engine power has the potential in some cases to cause flight to be prematurely terminated, the particular consequences of which cannot always be foreseen.

### BRIEF SUMMARY OF THE INVENTION

Therefore it is an object of the present invention to provide a filter element having a safety barrier formed therein that is configured to prevent pieces of a bypass valve from passing from the filter element while allowing flow of fluid to pass therethrough.

This and other objects are met by the present invention, which according to one aspect provides a valve failure protection device for use in a fluid filter element of the type including: (a) a filter media that defines an inner passage having first and second ends; and (b) a bypass assembly positioned in the second flow path for selectively permitting flow through the first end and the inner passage to the second end. The valve failure protection device includes a perforated safety barrier adapted to be positioned in the inner passage downstream of the bypass assembly, wherein the safety barrier is dimensioned to prevent the bypass assembly or pieces thereof from passing therethrough while permitting the flow of fluid along the inner passage to the second end.

According to another aspect of the invention, the safety barrier is cup-shaped.

According to another aspect of the invention, the cup-shaped safety barrier has tapered sides that have openings formed therethrough.

According to another aspect of the invention, the safety barrier is integrally formed with a tube adapted to be disposed within the inner passage.

According to another aspect of the invention, the tube comprises a first section and a second section and the safety barrier is integrally formed with the first section.

According to another aspect of the invention, the safety barrier is attached to a cap which is adapted to be positioned at the first end of the inner passage.

According to another aspect of the invention, the safety barrier and the cap are integrally formed.

According to another aspect of the invention, a filter element includes a filter media that defines an inner region having an inlet and an outlet. A first flow path is defined through the filter media and the inner region to the outlet and a second flow path that bypasses the filter media is defined through the inlet and the inner region to the outlet. A bypass assembly is positioned in the second flow path for diverting flow from the first flow path through the second flow path. A perforated safety barrier is positioned in the second flow path downstream of the bypass assembly wherein the safety barrier is dimensioned to prevent the bypass assembly or pieces thereof from passing therethrough while permitting the flow of fluid along the second flow path to the outlet.

### BRIEF DESCRIPTION OF THE DRAWINGS

The subject matter that is regarded as the invention may be best understood by reference to the following description taken in conjunction with the accompanying drawing figures in which:

FIG. 1 is an exploded view of a filter element constructed according to an aspect of the present invention.

FIG. 2 is a cross-sectional view of the filter of FIG. 1;

FIG. 3A is an end view of the filter media of the filter element of FIG. 1;

FIG. 3B is a cross-sectional view of the filter media of FIG. 3B;

FIG. 4 is an exploded view of an alternative filter element;

FIG. 5 is an exploded view of another alternative filter element; and

FIG. 6 is an exploded view of yet another alternative filter element.

### DETAILED DESCRIPTION OF THE INVENTION

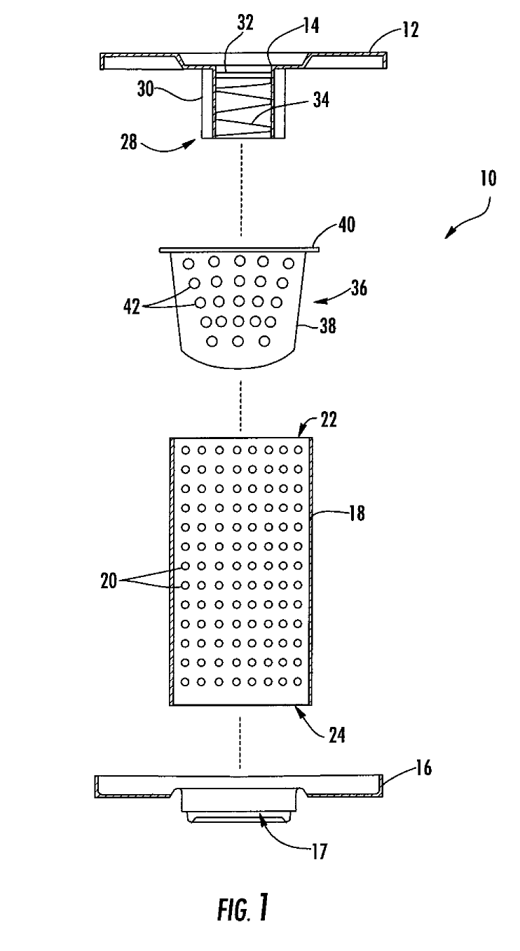

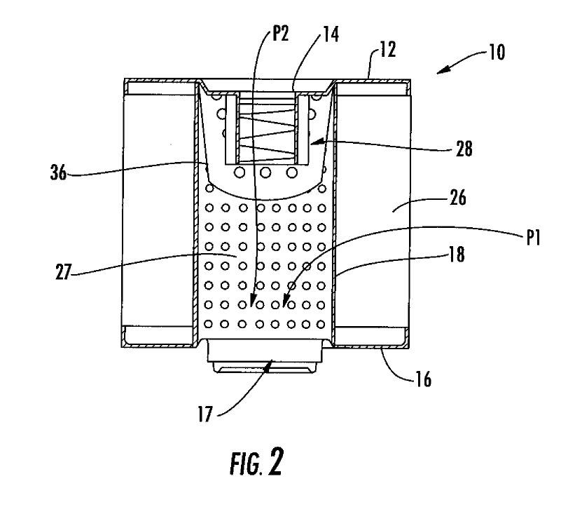

Referring to the drawings wherein identical reference numerals denote the same elements throughout the various views, FIGS. 1 and 2 illustrate an exemplary fluid filter element 10 constructed according to the present invention. The filter element 10 includes an upper element cap 12 with a bypass hole 14 formed therein, and a lower element cap 16 with an exit hole 17. The invention may also be implemented as a separate valve failure protection device to be used in a conventional filter element.

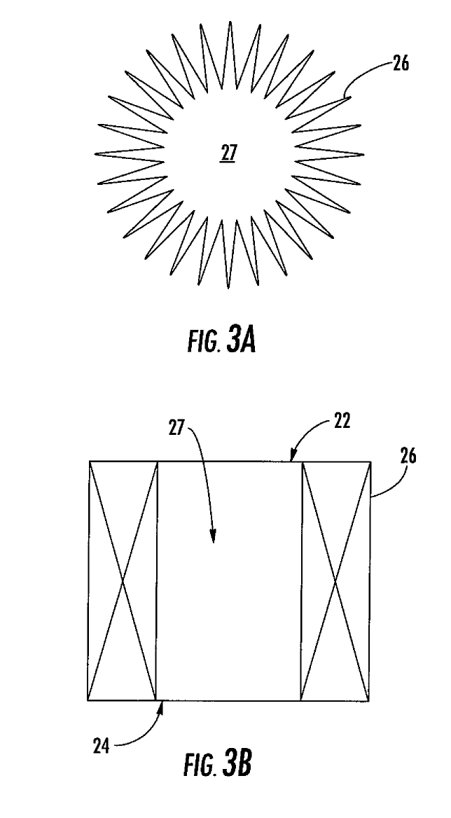

A generally cylindrical filter media 26 is captured between the upper and lower element caps 12 and 16. The filter media 26 surrounds an inner passageway or region 27 (see FIGS. 3A and 3B), which has first and second ends 22 and 24. In the illustrated example the filter media 26 comprises a pleated fibrous material, but any material that will permit fluid flow while excluding particles of a selected size may be used. Optionally, a hollow central tube 18 may be positioned within the passageway 27. The tube 18 has holes 20 formed therethrough and extends between the upper and lower element caps 12 and 16.

A first fluid flow path is generally defined from the outside of the filter media 26, through the filter media 26, passageway 27, holes 20 of tube 18 (if present) and to exit hole 17. In operation, inflow through the filter media 26 is generally radial from locations all around its periphery. For purposes of illustration, FIG. 2 shows an arrow “P1” representative of one route of fluid flow along the first flow path. A second fluid flow path is defined from outside of filter media 26 through first end 24, passageway 27, and to exit hole 17. The second fluid flow path bypasses filter media 26. Arrow “P2” is representative of one route of fluid flow along the second fluid flow path.

A bypass assembly 28 is positioned within the second fluid flow path P2 in fluid communication with the first end 22 and includes a bypass valve cage 30, a valve element 32, and a biasing element 34 which in this case is a coil spring. The valve element 32 is movable between a closed first position and an open second position. The biasing element 34 is configured to maintain valve element 32 in the first position such that first end 22 and the second fluid flow path P2 is blocked. When the difference in the pressure of fluid within passageway 27 and fluid in the area outside of filter media 26 exceeds a predetermined limit, the valve element 32 opens against the biasing element such that fluid can flow along the second fluid flow path P2. At any particular time when in operation, the valve element 32 may be fully closed, fully open, or in some intermediate position. Its exact position is proportional to the pressure difference across it. In actual operation, fluid flow may be solely along the first flow path P1, solely along the second flow path P2, or some combination of the two.

A safety barrier 36 is disposed in the second fluid flow path P2 between the bypass assembly 28 and the second end 24 such that the bypass assembly 28 is upstream of the safety barrier 36 in the second fluid flow path P2. In the illustrated example, the safety barrier 36 is an open-ended metallic cup with tapered sides 38 and a peripheral flange 40 at the open end. Perforations 42 are formed through the sides 38. Perforations 42 can be openings of any shape or configuration and in other embodiments can be formed through any portion of safety barrier 36. The safety barrier 36 is sufficiently strong to resist downstream flow of any part of the bypass assembly 28 and to capture such a part. In addition, perforations 42 of safety barrier 36 have a sufficient open area to permit a fluid flow around captured parts that is adequate for the needs of the protected fluid system. The safety barrier 36 could also be made from materials such as screen wire, perforated metal, or other materials having holes, slits, slots, or other openings therein.

The safety barrier 36 may be attached to the upper element cap 12 using any means which will retain it securely under the expected fluid pressure. Examples of suitable means include mechanical attachment or entrapment. Specific non-limiting examples include welding, brazing, fasteners such as screws or rivets, adhesive bonding, and crimping.

In the illustrated example, the safety barrier 36 is received in the central tube 18 before the upper element cap 12 is installed, and the flange 40 contacts the end of the central tube 18 so that the safety barrier 24 cannot move further into the central tube 18. When the filter element 10 is assembled, the end of the central tube 18, the flange 40, and the end of the filter media 26 are all bonded to the upper element cap 12, for example with an adhesive. This ensures that the safety barrier 36 is securely retained in place.

For use, the filter element 10 is placed in a suitable enclosure and connected in flow communication with the fluid system to be protected. The filter element 10 may be enclosed in a permanent housing which is part of the fluid system, or it may be enclosed in an outer shell (not shown) so as to form a self- contained filter.

In nominal operation, unfiltered fluid from the fluid system surrounds the filter element 10 and flows along the first fluid flow path P1 inward through the filter media 26 where foreign matter is trapped. The fluid flows through the holes 20 in the central tube 18, through the exit hole 17, and then back to the fluid system. As the filter media 26 becomes clogged through use or if the fluid is very viscous, a substantial pressure differential (“delta P”) can develop across the filter media. The characteristics of the bypass valve cage 30, valve element 32, biasing element 34, and the bypass hole 14 are selected so that when delta P exceeds a predetermined value, the valve element 32 will open, i.e., move between the first position to the second position, and permit some or all of the total fluid flow to flow along the second fluid flow path P2 from the bypass hole 14 down through the central tube 18 and through the outlet 24.

Should the bypass assembly 28 or any part thereof fail to the extent that it breaks loose and moves downstream, it will be retained by the safety barrier 36. In this manner, such parts are prevented from blocking the second end 24, exit hole 17, or passageways in the system downstream of the filter element 10. The perforations 42 in the safety barrier 36 are of sufficient size and quantity that they will allow an adequate fluid flow through the second end 24 and exit hole 17. In the embodiment shown in FIGS. 1 and 2, the side walls 38 of the safety barrier 36 are tapered inwards away from the central tube 18 so that a space is created between the two parts sufficiently large to accommodate oil flow. Any physical configuration of the safety barrier 36 and central tube 18 which avoids blockage of flow through the central tube 18, such as different diameters of the safety barrier 36 and the central tube 18, may be used in place of the tapered design shown.

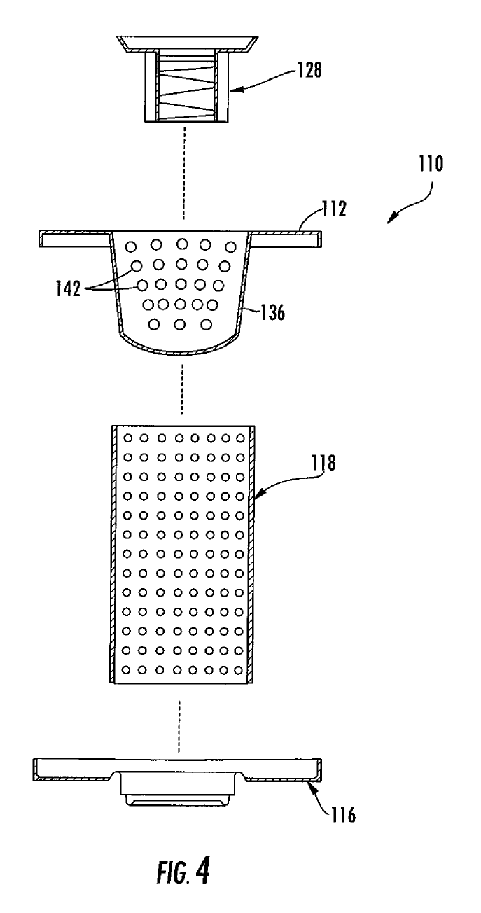

The physical structure of the safety barrier 36 may vary so long as it will block passage of the bypass assembly 28 or its components while permitting fluid flow therethrough. For example, FIG. 4 illustrates an alternative fluid filter element 110 similar in construction to the filter element 10 described above and including an upper element cap 112, a lower element cap 116, and a hollow central tube 118. The filter media, identical to filter media 26, is not shown.

A safety barrier 136, which is substantially similar to the safety barrier 36 described above, is integrally formed as one piece with the upper element cap 112. Safety barrier 136 and upper element cap 112 can be formed together by forming, molding, casting, turning, or the like. A bypass assembly 128, similar to the bypass assembly 28, is received in the interior of the safety barrier 136. The safety barrier 136 is sufficiently strong to resist downstream flow of any part of the bypass assembly 128 and has a sufficient open area, provided by perforations 142, to permit a fluid flow adequate for the needs of the protected fluid system.

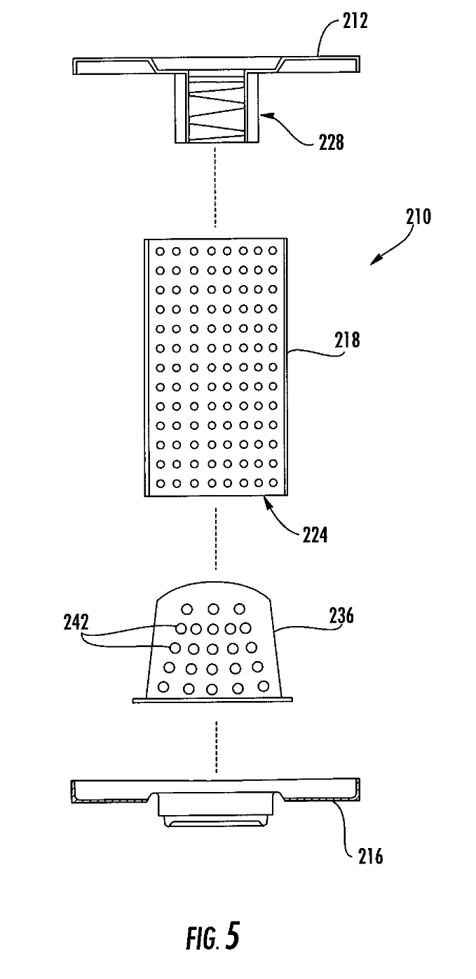

FIG. 5 illustrates another alternative fluid filter element 210 similar in construction to the filter element 10 described above and including an upper element cap 212, a lower element cap 216, a hollow central tube 218, and a bypass assembly 228. The filter media 226, identical to filter media 26, is not shown.

A safety barrier 236, which is substantially similar to the safety barrier 36 described above, is disposed in the outlet 224 of the central tube 218. The safety barrier 236 is sufficiently strong to resist downstream flow of any part of the bypass assembly 228 and has a sufficient open area, provided by perforations 242, to permit a fluid flow adequate for the needs of the protected fluid system.

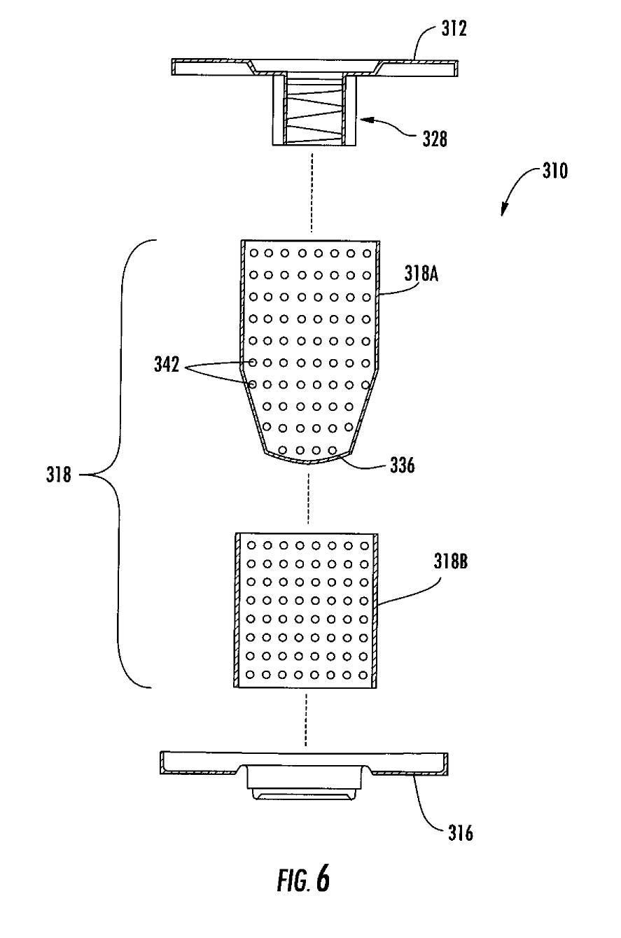

FIG. 6 illustrates yet another alternative fluid filter element 310 similar in construction to the filter element 10 described above and including an upper element cap 312, a lower element cap 316, a hollow central tube 318, and a bypass assembly 328. The filter media, identical to filter media 26, is not shown.

The central tube 318 comprises an upper section 318A and a lower section 318B. The upper section 318A has a cup-shaped safety barrier 336, which is substantially similar to the safety barrier 36 described above, integrally formed therein. The two sections of the central tube 318 may be simply pushed together or they may be attached to each other using welding, brazing, adhesives, fasteners, crimping or the like. The safety barrier 336 is sufficiently strong to resist downstream flow of any part of the bypass assembly 328 and has a sufficient open area, provided by perforations 242, to permit a fluid flow adequate for the needs of the protected fluid system. Alternatively, the upper section 318A may extend the entire length of central tube 318 and the lower section 318B may be omitted.

The foregoing has described a fluid filter element having a safety barrier. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A valve failure protection device for use in a fluid filter element of the type including a filter media that defines an inner passage having first and second ends and a bypass assembly positioned in the second flow path for selectively permitting flow through the first end and the inner passage to the second end, and comprising a perforated safety barrier adapted to be positioned in the inner passage downstream of the bypass assembly, wherein the safety barrier is dimensioned to prevent the bypass assembly or pieces thereof from passing therethrough while permitting the flow of fluid along the inner passage to the second end.

2. A valve failure protection device according to claim 1, wherein the safety barrier is cup-shaped.

3. A valve failure protection device according to claim 2, wherein the cup-shaped safety barrier has tapered sides that have openings formed therethrough.

4. A valve failure protection device according to claim 1 wherein the safety barrier is integrally formed with a tube adapted to be disposed within the inner passage.

5. A valve failure protection device according to claim 4 wherein the tube comprises a first section and a second section and the safety barrier is integrally formed with the first section.

6. A valve failure protection device according to claim 1 wherein the safety barrier is attached to a cap which is adapted to be positioned at the first end of the inner passage.

7. A valve failure protection device according to claim 7 wherein the safety barrier and the cap are integrally formed.

8. A filter element comprising:
a filter media that defines an inner passage having first and second ends;
a first flow path defined through the filter media and the inner passage to the second end;
a second flow path that bypasses the filter media defined through the first end and the inner passage to the second end;
a bypass assembly positioned in the second flow path for diverting flow from the first flow path through the second flow path; and
a perforated safety barrier positioned in the second flow path downstream of the bypass assembly wherein the safety barrier is dimensioned to prevent the bypass assembly or pieces thereof from passing therethrough while permitting the flow of fluid along the second flow path to the second end.

9. A filter element according to claim 9, wherein the safety barrier is cup-shaped.

10. A filter element according to claim 10, wherein the cup-shaped safety barrier has tapered sides that have openings formed therethrough.

11. A filter element according to claim 9 further comprising a tube having openings formed through a wall thereof disposed within the inner region passage such that fluid flowing along the first fluid path flows through the openings.

12. A filter element according to claim 12 wherein the safety barrier is integrally formed with the tube.

13. A filter element according to claim 12 wherein the tube comprises a first section and a second section and the safety barrier is integrally formed with the first section.

14. A filter element according to claim 9 further comprising a cap positioned at the inlet first end of the inner passage that is dimensioned to receive the bypass assembly.

15. A filter element according to claim 15 wherein the safety barrier and the cap are integrally formed.

16. A filter element according to claim 9 further comprising a cap positioned at the second end of the inner region that is dimensioned to receive the bypass assembly.

17. A filter element according to claim 17 wherein the safety barrier and the cap are integrally formed.
